(19) United States
(12) Patent Application Publication
(10) Pub. No.: US 2008/0073145 A1
(43) Pub. Date: Mar. 27, 2008

(54) SILENCER

(75) Inventors: Yasutaka Nakamura, Hamamatsu-Shi (JP); Kunio Hiyama, Hamamatsu-Shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: YAMAHA CORPORATION, Hamamatsu-Shi (JP)

(21) Appl. No.: 11/857,030

(22) Filed: Sep. 18, 2007

(30) Foreign Application Priority Data
Sep. 21, 2006 (JP) 2006-255467

(51) Int. Cl. F01N 1/10; G10K 11/00

(52) U.S. Cl. 181/252; 181/292

(57) ABSTRACT

In the silencer of the present invention, a cylindrical porous plate is provided on the outer circumferential side of a path forming component that forms a sound absorption path. The porous plate has a plurality of micro holes penetrating it in the thickness direction. By forming the plurality of micro holes on the outer circumferential side of the porous plate, sound generated by the air flowing along the sound absorption path is attenuated without any sound absorption material being used. The porous plate is formed from metal. As a result, there is no source for generating for dust and dirt such as sound absorption materials formed, for example, from connected foam resin and fiber. Accordingly, it is possible to reduce sound that is generated by the flow of air while also reducing the creation of dust and dirt.

Priority is claimed on Japanese Patent Application No. 2006-255467, filed Sep. 21, 2006, the contents of which are incorporated herein by reference.

### BACKGROUND OF THE INVENTION

1. Field of the Invention

The present invention relates to a silencer and, in particular, to a silencer that reduces noise generated by the flow of air.

2. Description of Related Art

Conventionally, a silencer is provided on the exhaust path of an engine in order, for example, to reduce exhaust noise and the like from the engine. A silencer has a volume chamber on an outer circumferential side of an exhaust pipe which forms the exhaust path. The volume chamber is filled with a sound absorption material that is formed, for example from glass fiber or foam resin or the like. By employing this type of structure, a reduction in the noise generated from air flowing along the exhaust path can be achieved in the silencer (see Japanese Utility Model Registration No. 3077427).

When a silencer is provided on a path whose end portion on the downstream side in the air flow direction is open to the atmosphere, such as the exhaust path of an engine which is mentioned above, even if dust or dirt from the glass fiber or foam resin which forms the sound absorption material is temporarily created, it is simply discharged into the atmosphere. However, if the end portion on the downstream side in the air flow direction is connected to a functional portion, then if dust or dirt from the sound absorption material of the silencer is created, the dust or dirt is taken into functional portions.

For example, in the case of an air supply apparatus that supplies air to a functional portion in the form of a fuel cell, a silencer is provided in the air supply apparatus in order to reduce air intake noise. In the fuel cell, the air path along which the air flows is a micro path whose size is between several μm and several tens of μm. Because of this, a filter is provided on the air intake side of the silencer in order to remove micro contaminants in the air. However, if the sound absorption material is formed from glass fiber or foam resin or the like, then even if contaminants in the introduced air are removed using a filter, there is a possibility that dust or dirt from the glass fiber or foam resin of the silencer that is placed on the fuel cell side of the filter will enter into the fuel cell. As a result of this, there is a possibility that the supply of air to the fuel cell will become obstructed and the functioning of the fuel cell will deteriorate.

Moreover, for example, in the case of an engine, a silencer is provided on the air intake path in order to reduce air intake noise. In this case, dust and dirt generated from the sound absorption material of the silencer enters into the engine via the air intake path. As a result, there is a possibility that this will lead to a deterioration in the functioning of the engine.

### SUMMARY OF THE INVENTION

Therefore, it is an object of the present invention to provide a silencer that reduces noise generated by the flow of air while also reducing the generation of dust and dirt.

The silencer of the present invention includes: a filter component that removes contaminants present in introduced air; an entry side path component that is connected to the filter component, and forms an entry path through which flows air that is introduced through the filter component; a casing that is connected to an end portion of the entry side path component that is on an opposite side from the filter component, and that forms a volume chamber that has a larger cross-sectional area than that of the entry path; an exit side path component that is connected to an end portion of the casing that is on the opposite side from the entry side path component, and that forms an exit path that has a smaller cross-sectional area than that of the volume chamber and through which flows air that has passed through the casing; and a sound absorption portion that has a cylindrical porous plate in which a plurality of micro holes have been formed, and that forms a sound absorption path that connects the entry side path component to the exit side path component in the interior of the casing, and that connects the end portion on the volume chamber side of the entry path to the end portion on the volume chamber side of the exit path on the inner circumferential side of the porous plate.

The sound absorption portion has a porous plate. The porous plate is formed in a cylindrical shape, and a sound absorption path that connects the entry path and the exit path is formed on the inner circumferential side of the porous plate inside the casing. The porous plate has a plurality of micro holes. By forming a plurality of micro holes in the porous plate and controlling the hole area ratio of these micro holes, sound generated from air that is flowing along this sound absorption path is attenuated. Moreover, compared to sound absorption materials that are formed, for example, from connecting foam resin and fiber, the porous plate is resistant to ripping, and the creation of dust and dirt is reduced. Accordingly, it is possible to reduce sound that is generated by the flow of air while also reducing the creation of dust and dirt.

In the silencer of the present invention, it is also possible for the sound absorption portion to be provided with: a sound absorption path forming component that is formed in a cylindrical shape and has the sound absorption path formed in the interior thereof and has apertures that penetrate side walls thereof and that connect the sound absorption path to the volume chamber; and with the porous plate that covers the outer circumferential side of the sound absorption path forming component.

Namely, the sound absorption portion may have a sound absorption path forming component that forms the sound absorption path and becomes a structural framework, and a porous plate that covers the outer circumferential side of this sound absorption path forming component. As a result, the sound absorption path and the volume chamber are connected via apertures that are formed in side walls of the sound absorption path forming component. Because of this, the sound of air that is flowing through this sound absorption path is transmitted to the porous plate that attenuates the sound via the apertures. Accordingly, it is possible to reduce sound that is generated by the flow of air while also reducing the creation of dust and dirt.

In the silencer of the present invention, it is also possible for the sound absorption path forming component and the porous plate to be substantially in tight contact with each other.

In the silencer of the present invention, it is also possible for a gap to be formed between the sound absorption path forming component and the porous plate.

In the silencer of the present invention, it is also possible for the porous plate to be formed from metal or resin.

As a result, the material used for the porous plate can be selected irrespective of the type of vapor that is passing through the sound absorption path. For example, by using a resin porous plate for vapor that causes metal to corrode, it is possible to prevent the porous plate corroding.

### BRIEF DESCRIPTION OF THE DRAWINGS

FIG. 1 is a block diagram showing a fuel cell module in which a silencer according to an embodiment of the present invention has been applied.

FIG. 2 is a schematic view showing an air supply apparatus in which a silencer according to an embodiment of the present invention has been applied.

FIG. 3A is a cross-sectional view taken along a plane that includes a center axis of the silencer according to an embodiment of the present invention.

FIG. 3B is a cross-sectional view taken along a line B-B in FIG. 3A.

FIG. 4 is a cross-sectional view showing the silencer according to an embodiment of the present invention.

FIG. 5 is a schematic view showing a measurement apparatus that measured characteristics of the silencer according to an embodiment of the present invention.

FIG. 6 is a schematic view showing a path forming component that forms an air path when no silencer is provided.

FIG. 7 is a cross-sectional view showing a silencer according to Comparative example 1.

FIG. 8 is a cross-sectional view showing a silencer according to Comparative example 2.

FIG. 9 is a graph showing octave band central frequencies and sound pressures in the cases of Example 1 of the silencer according to an embodiment of the present invention, Comparative example 1, Comparative example 2, and when no silencer is provided.

FIG. 10A is a cross-sectional view taken along a plane that includes a center axis of the silencer according to another embodiment of the present invention.

FIG. 10B is a cross-sectional view taken along a line B-B in FIG. 10A.

FIG. 11A is a cross-sectional view taken along a plane that includes a center axis of the silencer according to yet another embodiment of the present invention.

FIG. 11B is a cross-sectional view taken along a line B-B in FIG. 11A.

FIG. 12A is a cross-sectional view taken along a plane that includes a center axis of the silencer according to yet another embodiment of the present invention.

FIG. 12B is a cross-sectional view taken along a line B-B in FIG. 12A.

### DETAILED DESCRIPTION OF THE INVENTION

The silencer according to an embodiment of the present invention will now be described based on the drawings.

Here, an example in which a silencer is applied to an air supply apparatus of a fuel cell module is described as an example of the application of the silencer according to an embodiment of the present invention. Namely, the application of the silencer according to an embodiment of the present invention to a fuel cell module is nothing more than an example. Accordingly, a silencer that employs the structure of the present invention can be applied to apparatuses in which the generation of dust and dirt is undesired and in which a reduction in the noise that is created by the flow of air is demanded such as, for example, air intake apparatuses of vehicle engines or suctioning systems of clean rooms and the like.

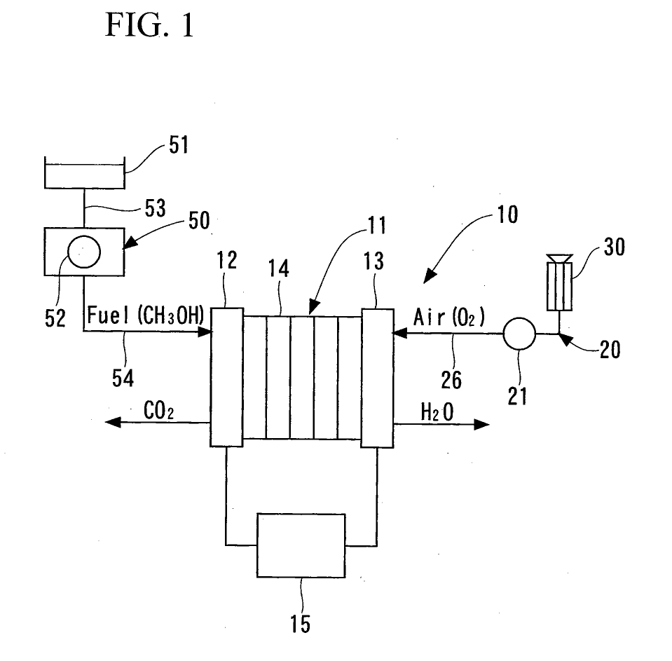

FIG. 1 is a block diagram showing the structure of a fuel cell module in which a silencer according to an embodiment of the present invention has been applied. A fuel cell module 10 is provided with a fuel cell 11. For example, a direct methanol fuel cell (DMFC) or the like may be used as the fuel cell 11. Note that, instead of the fuel cell 11, it is also possible to use a fuel cell stack that is formed by stacking a plurality of fuel cells 11. The fuel cell 11 has a fuel electrode 12, an air electrode 13, and an electrolyte membrane 14 that is sandwiched between the fuel electrode 12 and the air electrode 13. In the case of a DMFC, an aqueous solution of methanol is supplied as fuel to the fuel electrode 12 side, while air containing oxygen is supplied to the air electrode 13 side. Carbon dioxide is discharged as a reaction product from the fuel electrode 12 side, while a waste solution composed mainly of water is discharged as a reaction product from the air electrode 13 side. The fuel electrode 12 and the air electrode 13 are electrically connected to an external load 15.

The fuel cell module 10 is provided with an air supply apparatus 20 and a fuel supply apparatus 50. The air supply apparatus 20 takes in air from the atmosphere and supplies this intake air to the air electrode 13 of the fuel cell 11. The fuel supply apparatus 50 supplies fuel that is stored in a fuel tank 51 to the fuel electrode 12 of the fuel cell 11. The fuel supply apparatus 50 has a fuel pump 52. The fuel tank 51 is connected via a fuel intake path 53 to a fuel intake side of the fuel pump 52. The fuel tank 51 stores an aqueous solution of methanol as fuel. The discharge side of the fuel pump 52 is connected via the fuel supply apparatus 50 to the fuel electrode 12 of the fuel cell 11. As a result, the fuel supply path 54 supplies the methanol aqueous solution that has been taken in from the fuel tank 51 to the fuel electrode 12 of the fuel cell 11.

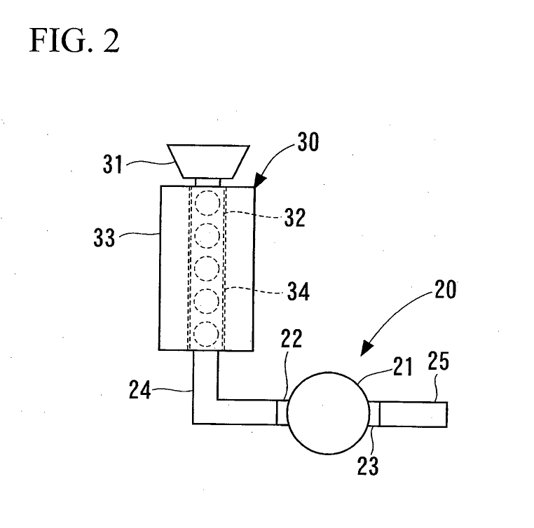

The air supply apparatus 20 is provided with a pump 21 and a silencer 30. The pump 21 is driven by an electrical motor (not shown) or the like. The pump 21 may also be housed, for example, in a housing (not shown) or the like. As is shown in FIG. 2, an intake portion 22 and a discharge portion 23 are connected to the pump 21. The intake portion 22 is connected via an intake path component 24 to a silencer 30. On the other hand, the discharge portion 23 is connected via a discharge path component 25 to an air supply path 26 shown in FIG. 1. The air supply path 26 is connected to the pump 21 and the air electrode 13 of the fuel cell 11.

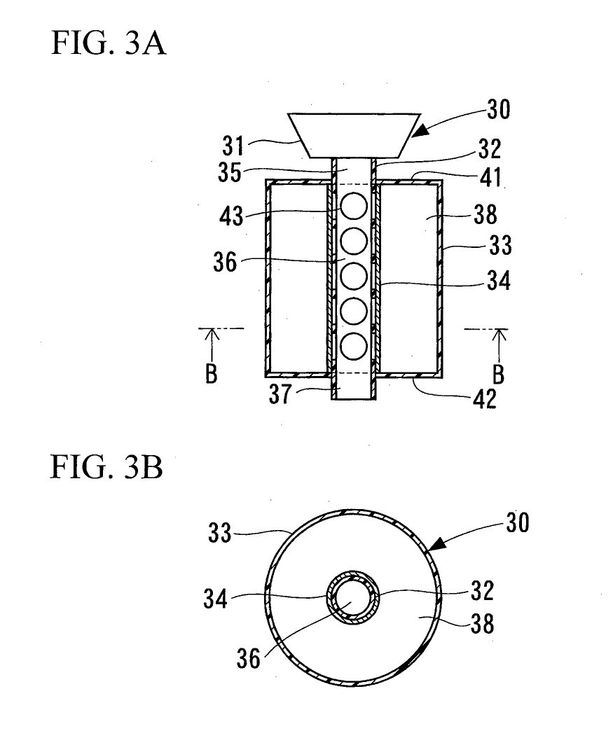

As is shown in FIG. 2 and FIGS. 3A and 3B, the silencer 30 is provided with a filter component 31, a path forming component 32, a casing 33, and a porous plate 34. The filter component 31 is mounted on one end portion in the axial direction of the path forming component 32. The filter component 31 collects contaminants that are contained in the air that is taken into the air supply apparatus 20. As a result, contaminants that are contained in the air passing through the filter component 31 is removed.

The path forming component 32 is formed in a hollow cylinder shape. The path forming component 32 has the filter component 31 at one end thereof in the axial direction. The path forming component 32 is formed as a single component that extends from an end portion on the filter component 31 side to an end portion on the opposite side. Namely, in the case of the present embodiment, the path forming component 32 has an entry side path component, a sound absorption path forming component, and an exit side path component that are formed as a unit in this order from the end portion on the filter component 31 side. Accordingly, on the inner circumferential side, the cylindrical path forming component 32 forms in this order from the end portion on the filter component 31 side an entry path 35, a sound absorption path 36, and an exit path 37. As a result, the entry path 35 and the exit path 37 are connected to the sound absorption path 36.

The casing 33 is mounted on an outer circumferential side of the path forming component 32. The casing 33 is formed in a circular cylinder shape with the path forming component 32 penetrating a central portion thereof. The inner diameter of the casing 33 is larger than the outer diameter of the path forming component 32. Accordingly, a cross-sectional area of a volume chamber 38 that is formed between the casing 33 and the path forming component 32 is larger than the cross-sectional area of the entry path 35, the sound absorption path 36, and the exit path 37 formed by the path forming component 32. The casing 33 may be formed as a single unit, or may be separated, for example, in the radial direction or axial direction into a plurality of components.

In the case of the present embodiment, the path forming component 32 and the casing 33 are formed from resin. Because of this, the path forming component 32 and the casing 33 are assembled into a single unit by, for example, adhesion or welding. The casing 33 has wall portions 41 and 42 at both ends portions in the axial direction thereof, namely, at the end portion on the entry path 35 side and the end portion on the exit path 37 side respectively. End portions on the inner circumferential side of the wall portions 41 and 42 are connected to the outer circumferential surface of the path forming component 32. Accordingly, the volume chamber 38 forms a space whose two end portions in the axial direction of the casing 33 are closed off by the wall portion 41 and the wall portion 42.

The path forming component 32 has aperture portions 43 in the portion where the sound absorption path 36 is formed, namely, between the wall portion 41 and the wall portion 42 of the casing 33. The aperture portions 43 penetrate side walls of the cylindrical path forming component 32. Accordingly, the sound absorption path 36 and the volume chamber 38 are connected via the aperture portions 43. In the case of the embodiment of the present invention shown in FIG. 2, the aperture portions 43 are formed in a circular shape. Moreover, in FIG. 2, an example is shown in which five aperture portions 43 are formed in the axial direction of the path forming component 32, while four aperture portions 43 are formed in the circumferential direction thereof. Note that the aperture portions 43 are not limited to a circular shape and they may also be formed in a slit shape extending in the axial direction. Moreover, the number and shape of the aperture portions 43 in the axial direction and circumferential direction of the path forming component 32 can be set as is desired in accordance with the frequency of the characteristic noise of the air are flowing through the sound absorption path 36 or in accordance with the air flow rate.

The porous plate 34 that covers the path forming component 32 including the aperture portions 43 is provided on the outer circumferential side of the path forming component 32 in the portion of the path forming component 32 which forms the sound absorption path 36, namely, between the wall portion 41 and the wall portion 42. The porous plate 34 continuously covers the outer circumferential side of the path forming component 32 in the axial direction. The porous plate 34 is formed, for example, by a thin metal plate made from stainless steel, aluminum, or copper, or is formed from a resin such as a plastic such as PET or polyimide. The porous plate 34 has a plurality of micro holes. The micro holes in the porous plate 34 penetrate the porous plate 34 in the plate thickness direction. The micro holes in the porous plate 34 may be formed, for example, by etching the thin metal plate, by removing portions of the metal plate using a laser or the like, or by weaving fine metal fibers in a mesh shape. If a plastic thin plate is used for the porous plate 34, then the micro holes may be formed using a press or punch. The path forming component 32 and the porous plate 34 which form the sound absorption path 36 constitute a sound absorption portion.

The porous plate 34 is provided so as to be substantially tightly adhered to the outer circumferential surface of the path forming component 32. However, if the porous plate 34 is provided on the outer circumferential surface of the circular cylinder-shaped path forming component 32, in some cases the porous plate 34 may not become completely adhered to the outer circumferential surface of the path forming component 32 due to its own deformation, and a slight gap may be formed between the porous plate 34 and the path forming component 32. It is permissible for a gap to be formed between the porous plate 34 and the path forming component 32 in this manner, and it is also permissible for this gap to be intentionally formed. The porous plate 34 may be fixed to the path forming component 32, for example, using an adhesive or the like. The porous plate 34 may also be fixed to the path forming component 32 by being fastened thereto using a ring component (not shown). Furthermore, the porous plate 34 may be fixed to the path forming component 32 by driving pins or the like into the path forming component 32. The means of fixing the porous plate 34 to the path forming component 32 can thus be selected as is desired.

Note that, in the above described embodiment, an example is described in which the entry path component, the sound absorption path forming component, and the exit path component are formed as a single unit in the path forming component 32. However, it is also possible for the entry path component, the sound absorption path forming component, and the exit path component to each be formed separately, or to each be formed as a single unit in a desired combination. Moreover, it is also possible to form the entry path component, the sound absorption path forming component, the exit path component, and the casing 33 in a desired combination after considering, for example, ease of assembly or release from the mold or the like.

Next, examples and comparative examples using the silencer 30 of the above described embodiment will be described.

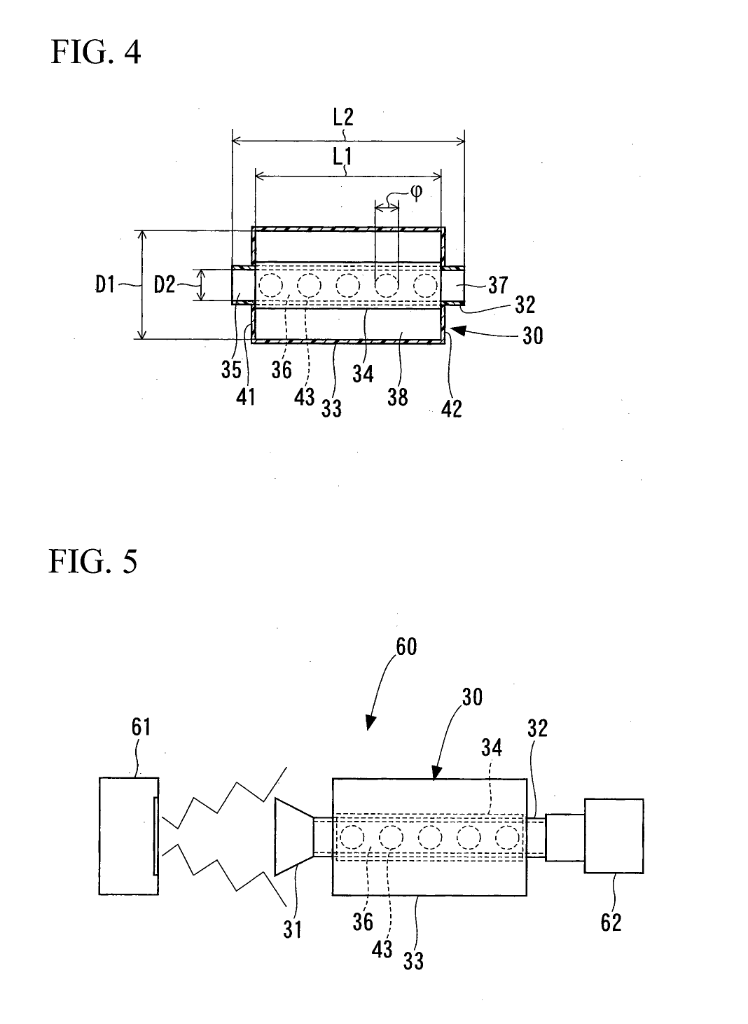

In the examples given below, as is shown in FIG. 4, the size of the silencer 30 is set. Namely, the inner diameter D1 of the casing 33 is set to 6 cm, while the overall length L1 thereof in the axial direction is set to 10 cm. The inner diameter D2 of the path forming component 32 is set to 2.2 cm, while the overall length L2 thereof in the axial direction is set to 14 cm. Moreover, the inner diameter φ of the aperture portions 43 of the path forming component 32 is 1.5 cm. In the respective examples and comparative examples, a variety of conditions are set for the porous plate that is mounted on the path forming component as is shown in Table 1.

TABLE 1

| | Metal porous plate | | | | Sound | |
|---|---|---|---|---|---|---|
| | | Plate | Aperture | Hole area | pressure | |
| | | thickness | diameter | ratio | level | |
| | Material | (μm) | (μm) | (%) | dB (F) | Remarks |
| No silencer | — | — | — | — | 63 | |
| Comparative | — | — | — | — | 58 | Reactive |
| example 1 | | | | | | type silencer |
| | | | | | | equipped with |
| | | | | | | an expansion |
| | | | | | | chamber |
| Comparative | — | — | — | — | 56 | Sound |
| example 2 | | | | | | absorption |
| | | | | | | material |
| | | | | | | type silencer |
| Example 1 | SUS | 50 | 75 | 0.9 | 56 | |
| Example 2 | SUS | 50 | 75 | 4.2 | 57 | |
| Example 3 | SUS | 50 | 75 | 35.4 | 58 | |
| Example 4 | SUS | 50 | 75 | 0.4 | 58 | |
| Comparative | SUS | 50 | 75 | 0.2 | 62 | |
| example 3 | | | | | | |
| Example 5 | SUS | 100 | 75 | 8.2 | 58 | |
| Example 6 | SUS | 100 | 75 | 2.8 | 56 | |
| Example 7 | SUS | 100 | 75 | 0.9 | 57 | |
| Example 8 | SUS | 200 | 75 | 22.7 | 58 | |
| Example 9 | SUS | 200 | 75 | 19.9 | 57 | |
| Example 10 | SUS | 200 | 75 | 5.7 | 56 | |
| Comparative | SUS | 200 | 75 | 1.2 | 59 | |
| example 4 | | | | | | |
| Example 11 | Aluminum | 100 | 75 | 8.2 | 58 | |
| Example 12 | Aluminum | 100 | 75 | 2.8 | 56 | |
| Example 13 | Aluminum | 100 | 75 | 0.9 | 57 | |
| Example 14 | Copper | 100 | 75 | 0.9 | 57 | |
| Example 15 | PET | 50 | 75 | 0.9 | 57 | |
| Example 16 | Polyimide | 50 | 75 | 0.9 | 57 | |
| Example 17 | SUS | 100 | 50 | 1.9 | 57 | |
| Example 18 | SUS | 100 | 100 | 3.6 | 57 | |
| Example 19 | SUS | 100 | 150 | 2.0 | 57 | |
| Example 20 | SUS | 100 | 200 | 0.9 | 57 | |

The conditions of the respective examples and comparative examples will now be described. In each of the examples and comparative examples described below, the hole area ratio is the ratio of the surface area of the micro holes relative to the total surface area of the porous plate 34.

In each of the examples and comparative examples described below, the sound pressure level is measured using a measurement apparatus 60 such as that shown in FIG. 5. The measurement apparatus 60 is formed by the silencer 30, a noise generating portion 61, and a sound pressure level detecting portion 62. The noise generating portion 61 generates noise of a predetermined frequency. The sound pressure level detecting portion 62 is connected to the silencer 30, and detects noise that is generated by the noise generating portion 61 and passes through the silencer 30. In this measurement of the sound pressure level, after the silencers of the respective examples and comparative examples have been mounted on the measurement apparatus 60, noise is generated by the noise generating portion 61 as the frequency is being changed, and this noise passes through the silencer and is detected by the sound pressure level detecting portion 62. Accordingly, the silencing characteristics of the silencer are measured for each frequency.

### (Comparison of Silencer Modes)

In order to compare silencing characteristics according to silencer mode, comparisons were made between Example 1, Comparative example 1, Comparative example 2, and when no silencer was provided.

In Example 1, the material used for the porous plate 34 of the silencer 30 was stainless steel, while the plate thickness was 50 μm and the aperture diameter of the micro holes was 75 μm. The hole area ratio of the porous plate 34 was set to 0.9%.

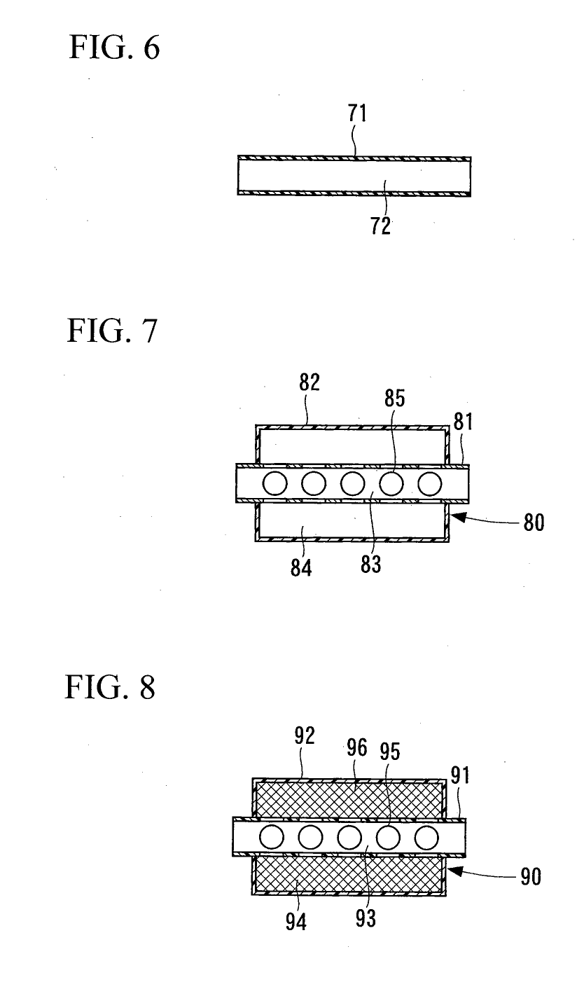

In the case where the silencer 30 is not provided, as is shown in FIG. 6, only a path forming component 71 is connected to the pump 21. The path forming component 71 is a simple cylinder-shaped component having no aperture portions in the side walls thereof, and an air path 72 is formed on the inner circumferential side thereof.

Moreover, in Comparative example 1, a reactive type silencer equipped with an expansion chamber was used. As is shown in FIG. 7, in the reactive type silencer 80 equipped with an expansion chamber according to Comparative example 1, a casing 82 is provided on an outer circumferential side of a path forming component 81. Aperture portions 85 that connect a sound absorption path 83 that is formed by the path forming component 81 with a volume chamber 84 that is formed between the path forming component 81 and the casing 82 are formed in side walls of the path forming component 81. In the case of the silencer 80 of Comparative example 1, the path forming component 81 is formed, for example, from a metal such as stainless steel and the aperture portions 85 are formed by press working or the like. In contrast, the casing 82 is formed from resin.

Typically, the reactive type silencer equipped with an expansion chamber changes the cross-sectional area of the path through which air flows so that there is a reduction in the size of the noise as it transits from a path having a small cross-sectional area to a path having a large cross-sectional area. In the case of the reactive type silencer equipped with an expansion chamber, the reduction in the sound volume is determined by the ratio of the small cross-sectional area path side to the large cross-sectional area expansion side. Moreover, in the reactive type silencer equipped with an expansion chamber, the reduction in the frequency is determined by the length of the volume chamber on the expansion side.

In Comparative example 2, a sound absorption material type of silencer was used. As is shown in FIG. 8, in a sound absorption material type silencer 90 according to Comparative example 2 a casing 92 is provided on an outer circumferential side of a path forming component 91. Aperture portions 95 that connect a sound absorption path 93, which is formed by the path forming component 91, to a volume chamber 94, which is formed between the path forming component 91 and the casing 92, are formed in side walls of the path forming component 91. In the case of the silencer 90 of Comparative example 2, the path forming component 91 and the casing 92 are formed from resin. Moreover, the volume chamber 94 which is formed between the path forming component 91 and the casing 92 is filled with a porous sound absorption material 96 that is formed from polyurethane foam. Note that, instead of the porous sound absorption material 96, the volume chamber 94 may also be filled with a fiber-based sound absorption material such as glass fiber or felt.

### (Effect of the Hole Area Ratio of the Porous Plate)

In order to compare the hole area ratios of the porous plates 34 with the silencing characteristics, comparisons were made between Example 2, Example 3, Example 4, and Comparative example 3.

In Examples 2 through 4 and Comparative example 3, the material used for the porous plate 34 of the silencer 30 in each case was stainless steel having a plate thickness of 50 μm and having a hole diameter for the micro holes of 75 μm.

In Example 2, the hole area ratio of the porous plate 34 was set to 4.2%.

In Example 3, the hole area ratio of the porous plate 34 was set to 35.4%.

In Example 4, the hole area ratio of the porous plate 34 was set to 0.4%.

In Comparative example 3, the hole area ratio of the porous plate 34 was set to 0.2%.

### (Effect of the Plate Thickness of the Porous Plate)

In order to compare the plate thicknesses of the porous plates 34 with the silencing characteristics, comparisons were made between Examples 5 through 10 and Comparative example 4.

In Examples 5 through 10 and Comparative example 4, the material used for the porous plate 34 of the silencer 30 in each case was stainless steel having a hole diameter for the micro holes of 75 μm.

In Example 5, the plate thickness of the porous plate 34 was 100 μm and the hole area ratio was 8.2%.

In Example 6, the plate thickness of the porous plate 34 was 100 μm and the hole area ratio was 2.8%.

In Example 7, the plate thickness of the porous plate 34 was 100 μm and the hole area ratio was 0.9%.

In Example 8, the plate thickness of the porous plate 34 was 200 μm and the hole area ratio was 22.7%.

In Example 9, the plate thickness of the porous plate 34 was 200 μm and the hole area ratio was 19.9%.

In Example 10, the plate thickness of the porous plate 34 was 200 μm and the hole area ratio was 5.7%.

In Comparative example 4, the plate thickness of the porous plate 34 was 200 μm and the hole area ratio was 1.2%.

### (Effect of the Material of the Porous Plate)

In order to compare the materials of the porous plates 34 with the silencing characteristics, comparisons were made between Examples 11 through 14.

In Examples 11 through 14, in each case the plate thickness was 100 μm and the hole diameter for the micro holes of 75 μm. In Examples 15 and 16, in each case the plate thickness was 50 μm and the hole diameter for the micro holes of 75 μm.

In Example 11, the material of the porous plate 34 was aluminum and the hole area ratio was 8.2%.

In Example 12, the material of the porous plate 34 was aluminum and the hole area ratio was 2.8%.

In Example 13, the material of the porous plate 34 was aluminum and the hole area ratio was 0.9%.

In Example 14, the material of the porous plate 34 was copper and the hole area ratio was 0.9%.

In Example 15, the material of the porous plate 34 was PET (polyethylene terephthalate) and the hole area ratio was 0.9%.

In Example 16, the material of the porous plate 34 was polyimide and the hole area ratio was 0.9%.

### (Effect of the Hole Diameter of the Porous Plate)

In order to compare the hole diameters of the porous plates 34 with the silencing characteristics, comparisons were made between Examples 17 through 20.

In Examples 17 through 20, the material used for the porous plate 34 of the silencer 30 in each case was stainless steel having a plate thickness of 100 μm.

In Example 17, the hole diameter of the micro holes of the porous plate 34 was 50 μm and the hole area ratio was 1.9%.

In Example 18, the hole diameter of the micro holes of the porous plate 34 was 100 μm and the hole area ratio was 3.6%.

In Example 19, the hole diameter of the micro holes of the porous plate 34 was 150 μm and the hole area ratio was 2.0%.

In Example 20, the hole diameter of the micro holes of the porous plate 34 was 200 μm and the hole area ratio was 0.9%.

### (Results of the Comparisons)

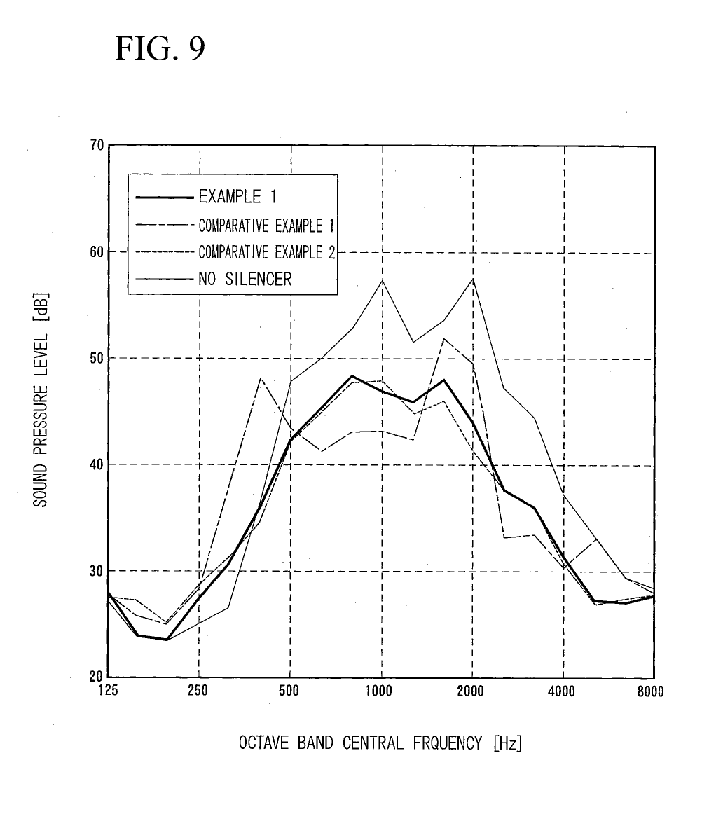

The results when the various modes of silencer were compared are shown in FIG. 9. In FIG. 9, an outline of relationships between octave band central frequencies and sound pressures in the cases of the respective silencers 30, 80, and 90 of Example 1, Comparative example 1, and Comparative example 2, and when no silencer is provided.

As is shown in FIG. 9, compared with when no silencer is provided, a reduction in the sound pressure was evident in substantially all frequency regions in the silencer 30 of Example 1, the silencer 80 of Comparative example 1, and the silencer 90 of Comparative example 2. However, in the silencer 80 of Comparative example 1, there was a bulge in the sound pressure in a portion of the frequency range where a reduction in the sound pressure was not achieved. It is thought that this is because, in the case of Comparative example 1 in which the silencer 80 is the reactive type silencer equipped with an expansion chamber, due to the characteristics thereof only the sounds of specific frequencies are reduced and the sounds of other frequencies are increased as a result of, for example, resonance and the like.

The silencer 30 of Example 1 exhibits substantially the same silencing characteristics in each frequency region as the silencer 90 of Comparative example 2 that has been filled with a sound absorption material. As a result, it was discovered that, without utilizing any sound absorption material that becomes a source of dust and dirt, the silencer 30 of Example 1 manifested the same silencing characteristics as Comparative example 2 that was filled with the sound absorption material 96.

Next, relationships between the various types of porous plate 34 and silencing characteristics will be compared with reference made to Table 1.

In Example 2and Example 3, it was discovered that if the hole area ratio of the micro holes of the porous plate 34 is increased, there was an increase in the noise level. It is thought that this is because, if the hole area ratio of the micro holes is increased, then the characteristics are analogous to those of a state in which the porous plate 34 is not provided, namely, to the reactive type silencer 80 of Comparative example 1.

In contrast, in Example 4and Comparative example 3, if the hole area ratio of the micro holes of the porous plate 34 is decreased, there was an increase in the noise level. It is thought that this is because, if the hole area ratio of the micro holes is decreased, then the characteristics are analogous to those of a thin plate in which micro holes have not been formed, namely, to a state in which there is no silencer.

In Example 5 through Example 10 and Comparative example 4, it was discovered that, when the plate thickness of the porous plate 34 is increased, then if there is no increase in the hole area ratio of the micro holes, there was an increase in the noise level. Namely, by increasing the hole area ratio of the micro holes in accordance with the increase in the plate thickness of the porous plate 34, the silencing characteristics of the silencer 30 are maintained. It is thought that this is because, when the plate thickness of the porous plate 34 is increased, the overall length of the micro holes is lengthened in correspondence with the plate thickness which causes a reduction in the apparent hole area ratio so that the characteristics approximate those of a state in which no silencer is provided.

In Example 11 through Example 16, it was discovered that the material used for the porous plate 34 had a significant effect on the silencing characteristics of the silencer 30. However, in Example 15 and Example 16 in which the porous plate 34 was formed from a thin plastic plate, there was a slight increase in the noise level. It is thought that this is because, in the case of the plastic porous plate 34, the micro holes are formed by punching using, for example, a press or punch. As a result, compared with a metal porous plate 34, there is a decrease, for example, in the micro hole formation accuracy or in the accuracy of the shape thereof.

Moreover, a plastic porous plate 34 is able to be used in air that includes vapor having corrosive elements such as, for example, hydrochloric acid and sulfuric acid. In contrast to this, for example, as in the case of a silencer used in a paint workshop, there is a possibility that air that contains the vapor of organic solvents will cause a plastic porous plate 34 to dissolve, which is clearly unacceptable. Furthermore, when there is a high flow rate of the air flowing through the noise absorption path 36, and also when the air temperature is high, there is a possibility that there will be a deterioration in the strength of a plastic porous plate 34.

In contrast, a metal porous plate 34 is able to be used in vapor that contains the vapor of organic solvents, or in air having a high temperature or high flow rate, or in air having a high temperature. In contrast to this, for example, as in the case of a silencer used in a plating workshop, it is undesirable for a metal porous plate 34 to be used for air containing vapor having corrosive elements such as, for example, the aforementioned hydrochloric acid and sulfuric acid. In this manner, a desired material used for the porous plate 34 can be selected after considering the ease of micro hole formation, the cost of materials, or the vapor in which it is to be used and the like.

In Example 17 through Example 20, when the hole diameter of the micro holes of the porous plate 34 was changed, then by adjusting the hole area ratio, the silencing characteristics of the silencer 30 are maintained. Namely, a desired combination of the hole diameter and hole area ratio of the micro holes can be set in accordance with the frequency of the air flowing through the sound absorption path 36 or with the flow rate of this air.

In Table 1 above it is determined that the silencing effect is satisfactory if the noise level is no more than 58 dB (F). Moreover, in the case of the respective examples of the present embodiment, even if the noise level is 58 dB (F), sound pressure peaks in specific frequencies are not evident as they are in Comparative example 1. Because of this, in the respective examples of the present embodiment, noise that is hard on the ear which is caused by sound of specific frequencies is reduced and there is an improvement in the overall silencing characteristics.

As has been described above using the respective examples, in the silencer 30 according to an embodiment of the present invention, the sound of air flowing along the sound absorption path 36 is reduced without sound absorption material being used. The porous plate 34 is provided in a cylindrical shape on the outer circumferential side of the path forming component 32 that forms the sound absorption path 36. By forming a plurality of micro holes in the porous plate 34, sound generated by the air flowing through the sound absorption path 36 is attenuated. The porous plate 34 is formed from metal. As a result, it is difficult for dust and dirt from sound absorption materials such as, for example, resin and fiber to be generated. Accordingly, it is possible to reduce sound that is generated by the flow of air while also reducing the creation of dust and dirt.

Moreover, because the silencer 30 reduces the sound of air flowing along the sound absorption path 36 using the porous plate 34, the creation of dust and dirt is reduced. Because of this, air from which contaminants have been removed by the filter component 31 flows into a downstream functional portion without containing any contaminant that has been generated from the silencer 30. As a result, when, as in the present embodiment, the silencer 30 is used in a fuel cell module 10, the supplying of air which contains contaminants to the fuel cell 11 is reduced. Accordingly, blockages of the air path of the fuel cell 11 and the like are reduced and the functioning of the fuel cell 11 can be demonstrated consistently over a considerable period of time.

### OTHER EMBODIMENTS

In the above described embodiment of the present invention, a structure is described in which the porous plate 34 is mounted so as to be substantially in tight contact with the outer circumferential side of the path forming component 32 that forms the sound absorption path 36 as a sound absorption portion. However, in the present invention, the positional relationship between the path forming component and the porous plate is not limited to that of the above described embodiment. Additional embodiments of the silencer according to the present invention are described below.

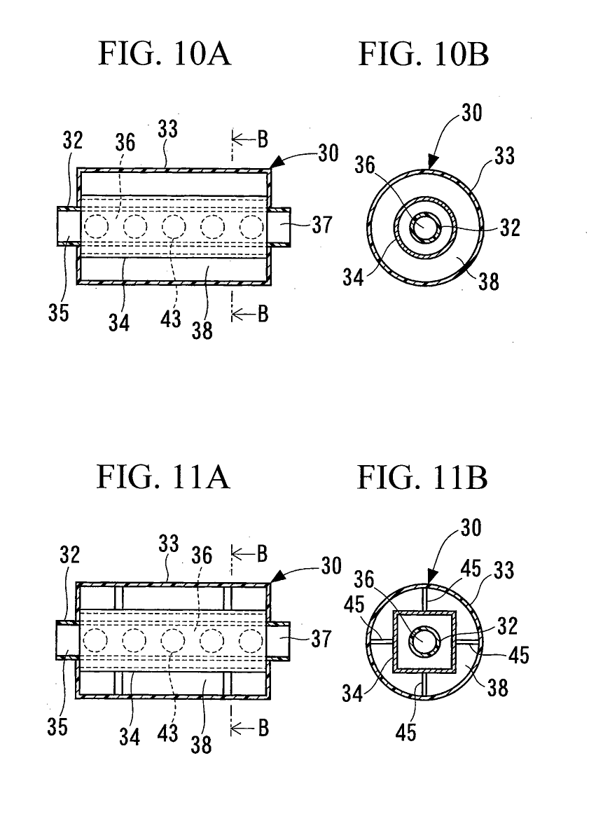

As is shown in FIGS. 10A and 10B, it is also possible to form the path forming component 32 and the porous plate 34 of the silencer 30 at a predetermined distance from each other. Namely, a predetermined gap may be formed between the path forming component 32 and the porous plate 34.

Moreover, as is shown in FIGS. 11A and 11B, it is also possible for the porous plate 34 of the silencer 30 to be formed such that the cross section thereof that is perpendicular to the axis is a rectangular shape. Namely, it is not necessary for the porous plate 34 to have a similar cross-sectional configuration to that of the path forming component 32, and it can be set to a desired configuration such as an elliptical configuration or a polygonal configuration. In this case, a structure may be employed in which a supporting portion 45 is provided between the casing 33 and the porous plate 34, and the porous plate 34 is supported on the casing 33 by this supporting portion 45.

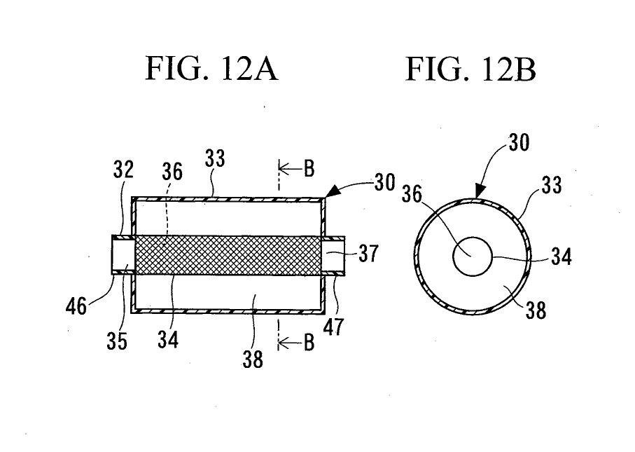

Furthermore, as is shown in FIG. 12A and FIG. 12B, it is also possible to employ a structure in which the sound absorption path 36 is formed directly by the porous plate 34. Namely, the path forming component 32 may be eliminated, and a cylindrical porous plate 34 may be mounted inside the casing 33 that has an entry portion 46 and an exit portion 47 formed either integrally therewith or separately therefrom. By employing this structure, the cylindrical porous plate 34 forms the sound absorption path 36 on the inner circumferential side thereof.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A silencer comprising:
a filter component that removes contaminants present in introduced air;
an entry side path component that is connected to the filter component, and forms an entry path through which flows air that is introduced through the filter component;
a casing that is connected to an end portion of the entry side path component that is on an opposite side from the filter component, and that forms a volume chamber that has a larger cross-sectional area than that of the entry path;
an exit side path component that is connected to an end portion of the casing that is on the opposite side from the entry side path component, and that forms an exit path that has a smaller cross-sectional area than that of the volume chamber and through which flows air that has passed through the casing; and
a sound absorption portion that has a cylindrical porous plate in which a plurality of micro holes have been formed, and that forms a sound absorption path that connects the entry side path component to the exit side path component in the interior of the casing, and that connects the end portion on the volume chamber side of the entry path to the end portion on the volume chamber side of the exit path on the inner circumferential side of the porous plate.

2. The silencer according to claim 1, wherein the sound absorption portion is provided with: a sound absorption path forming component that is formed in a cylindrical shape and has the sound absorption path formed in the interior thereof and has apertures that penetrate side walls thereof and that connect the sound absorption path to the volume chamber; and with the porous plate that covers the outer circumferential side of the sound absorption path forming component.

3. The silencer according to claim 2, wherein the sound absorption path forming component and the porous plate are substantially in tight contact with each other.

4. The silencer according to claim 2, wherein a gap is formed between the sound absorption path forming component and the porous plate.

5. The silencer according to claim 1, wherein the porous plate is formed from metal or resin.
